(19) United States
(12) Patent Application Publication
(10) Pub. No.: US 2017/0016855 A1
(43) Pub. Date: Jan. 19, 2017

(54) AUTOMATIC ELECTROPHORESIS APPARATUS

(71) Applicant: Sharp Kabushiki Kaisha, Sakai City, Osaka (JP)

(72) Inventors: Hiroshi OHKI, Osaka-shi (JP); Uichi MIDORIKAWA, Osaka-shi (JP); Shinichi GOTO, Osaka-shi (JP); Tsuyoshi TANAKA, Osaka-shi (JP); Yutaka UNUMA, Osaka-shi (JP)

(21) Appl. No.: 15/107,186

(22) PCT Filed: Dec. 8, 2014
(86) PCT No.: PCT/JP2014/082402

§ 371 Date: Jun. 22, 2016

(30) Foreign Application Priority Data
Dec. 24, 2013 (JP) 2013-265687

(51) Int. Cl. G01N 27/447

(52) U.S. Cl. CPC G01N 27/44739

(57) ABSTRACT

An automatic electrophoresis apparatus includes: a transfer film supply unit configured to supply a transfer film; a sample transfer unit configured to transfer a sample separated by electrophoresis to the transfer film; a post-processing unit configured to perform processing of the transfer film, to which the sample has been transferred, to obtain a transfer image thereof; and a transporting unit configured to transfer the transfer film along a transporting direction between each of units. The transfer film is provided with guide members that are configured to guide and support along the transporting direction.

### TECHNICAL FIELD

The present invention relates to an automatic electrophoresis apparatus.

The subject application claims priority based on the patent application No. 2013-265687 filed in Japan on Dec. 24, 2013 and incorporates by reference herein the content thereof.

### BACKGROUND ART

Electrophoresis is a method for separating molecules of a subject under analysis (sample) by passing a current through a separation medium, with an intervening buffer solution. Electrophoresis is widely used as a method for separating molecules having a large molecular weight, such as molecules in a biogenic sample, by using the differences in the characteristics thereof. Various methods and apparatuses have been developed for the purpose of fixing and analyzing proteins and nucleic acids.

For example, a method known as SDS-polyacrylamide gel electrophoresis (SDS-PAGE), which uses sodium dodecyl sulfate (SDS), which is a negative-ion surfactant, is widely used to separate proteins. Western blotting is well-known as a method for analyzing and identifying separated proteins. Western blotting is a method for transferring and fixing proteins separated by electrophoresis from a gel by adsorption onto a transfer film, which is an adsorbing member, and for identifying proteins by antigen-antibody interaction.

Because these separation and identification methods are very superior with regard to specificity and detection sensitivity, they are widely used as highly reliable analysis technologies in fields such as medicine, pharmacology, biochemistry, and foods.

A variety of methods have been studied for performing electrophoresis and transfer in a short period of time. For example, a method has been disclosed in which the gel exposed at the electrophoresis downstream end is brought into contact with a transfer film while performing electrophoresis, and the transfer film is moved while the contacting is maintained, so as to successively transfer molecules separated from a sample by electrophoresis to the transfer film immediately. This method is one that performs electrophoresis and transfer simultaneously and is suitable also for automation.

For example, in testing for serum proteins, an automatic electrophoresis apparatus is used (refer to, for example, Patent References 1 to 3). Specifically, Patent References 1 and 2 noted below disclose an automatic electrophoresis apparatus in which a carrier wetting unit that wets the carrier (transfer film) with buffer solution, a sample coating unit that coats the sample onto the carrier, an electrophoresis unit that passes electricity through the carrier onto which the sample was coated, a post-processing unit that subjects the carrier after electrophoresis to dying, color removal, and drying, and a photometric unit that measures the dyed electrophoresis image are successively linked, so that the carrier is successively transported to each of the processing units. Patent Reference 3 discloses an automatic electrophoresis apparatus having a mechanism that, in order to establish the stopping position of the carrier in the electrophoresis tank, detects the rear edge (or front edge) of the carrier being transported by a photosensor or the like, and stops the carrier after being transported for a certain length of time.

### PRIOR ART REFERENCES

### Patent References

[Patent Reference 1] Japanese patent 3071908

[Patent Reference 2] Japanese patent 3159499

[Patent Reference 3] Japanese patent 3349752

### SUMMARY OF THE INVENTION

### Problem to Be Solved by the Invention

In a conventional automatic electrophoresis apparatus, after coating the sample onto the transfer film, because successive transport to the electrophoresis unit, the post-processing unit, and the photometric unit has been done, there has been a problem of preventing contamination between samples (cross-contamination). Also, the transfer film could be broken during transport, and there has been a demand for improved transport accuracy.

One aspect of the present invention has been proposed in view of the conventional situation and has as one object to provide an automatic electrophoresis apparatus capable of improving the accuracy of transporting the transfer film, while preventing cross-contamination of the transfer film.

### Means for Solving the Problems

To achieve the above-described object, the present invention has adopted the following means.

(1) An automatic electrophoresis apparatus according to one aspect of the present invention comprising: a transfer film supply unit configured to supply a transfer film; an electrophoresis transfer unit configured to transfer a sample separated by electrophoresis to the transfer film; a post-processing unit configured to perform processing of the transfer film, to which the sample has been transferred, to obtain a transfer image thereof; and a transporting unit configured to transfer the transfer film along a transporting direction between each of units, wherein the transfer film is provided with guide members that are configured to guide and support along the transporting direction.

(2) In the automatic electrophoresis apparatus according to the (1), the guide members may be configured to be disposed along edge parts on both side of the transfer film, and disposed in a direction that is parallel to the transporting direction of the transfer film.

(3) In the automatic electrophoresis apparatus according to the (1) or (2), the guide members may be configured to be provided with a plurality of holes that are arranged with a prescribed spacing.

(4) In the automatic electrophoresis apparatus according to any one of the (1) to (3), the automatic electrophoresis apparatus may comprise a sample making unit configured to oppose the guide members of the transfer film and make a sample cell onto which a carrier is mounted.

(5) In the automatic electrophoresis apparatus according to the (4), the automatic electrophoresis apparatus may comprise a sample storage unit configured to store the sample cell.

(6) In the automatic electrophoresis apparatus according to any one of the (1) to (5), the automatic electrophoresis apparatus may comprise a measurement unit configured to measure a transfer image of the sample.

### Effect of the Invention

As noted above, according to one aspect of the present invention, it is possible to provide an automatic electrophoresis apparatus capable of improving the accuracy of transporting the transfer film, while preventing cross-contamination of the transfer film.

### BRIEF DESCRIPTION OF THE DRAWINGS

FIG. 1 shows, in schematic form, the general constitution of an automatic electrophoresis apparatus according to a first embodiment of the present invention.

FIG. 2A is an oblique view of the transfer film provided with guide members.

FIG. 2B is a cross-sectional view along the line segment X-X shown in FIG. 2A.

FIG. 2C is a cross-sectional view along the line segment Y-Y shown in FIG. 2A.

FIG. 3A is a cross-sectional view showing the condition of the carrier before being hot-pressed to the transfer film 100.

FIG. 3B is a cross-sectional view showing the condition of the carrier after being hot-pressed to the transfer film 100.

FIG. 4 shows, in schematic form, the general constitution of an automatic electrophoresis apparatus according to a second embodiment of the present invention.

FIG. 5 shows, in schematic form, an enlarged view of the guide roller.

FIG. 6 is a side view showing the stacked condition of transfer films to which the carrier is mounted.

### EMBODIMENTS FOR CARRYING OUT THE INVENTION

Embodiments of the present invention are described in detail below, with references being made to the drawings.

In all the drawings noted below, in order to make the constituent elements easy to see, the dimensional scales of some thereof have been shown changed.

### First Embodiment

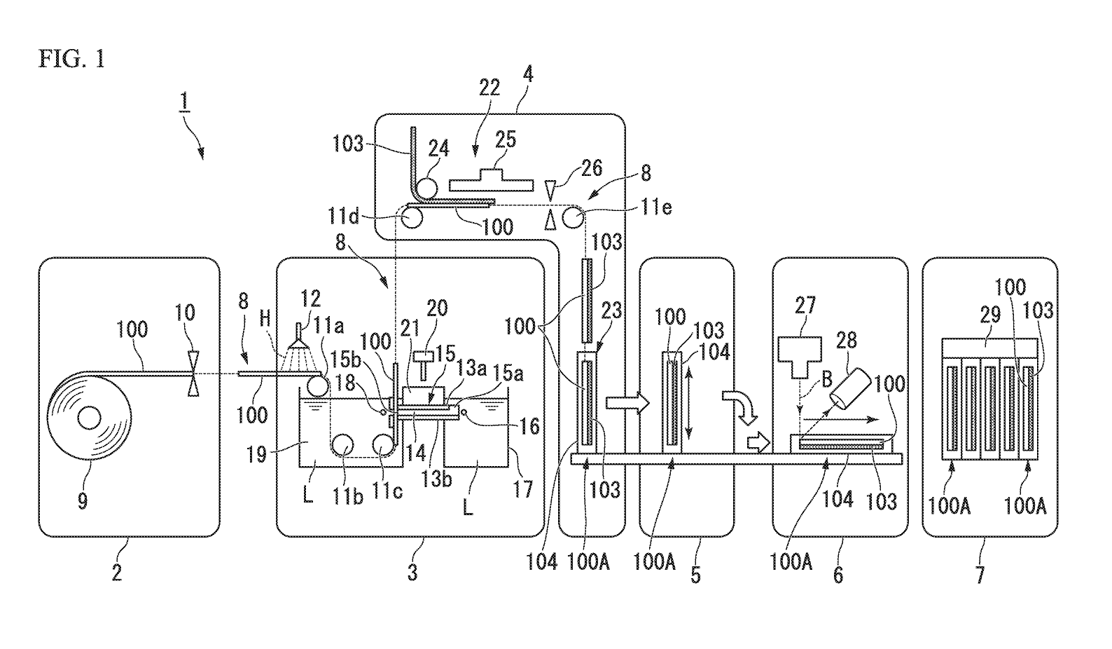

First, an automatic electrophoresis apparatus 1 shown in FIG. 1 will be described as the first embodiment of the present invention, using the example of testing for, for example, serum proteins. FIG. 1 is a schematic representation of the general constitution of the automatic electrophoresis apparatus 1.

As shown in FIG. 1, the automatic electrophoresis apparatus 1 generally has a transfer film supply unit 2, an electrophoresis transfer unit 3, a sample making unit 4, a post-processing unit 5, a measurement unit 6, a sample storage unit 7, and a transporting unit 8.

The transfer film suppler 2 has a transfer film roll 9 onto which the long ribbon-shaped transfer film 100 is wound and a cutter 10 that cuts the transfer film 100 fed out from the transfer film roller 9 to a prescribed length. Having been cut to the prescribed length, the transfer film 100 is successively transported by the transporting unit 8 from the transfer film supply unit 2 to the electrophoresis transfer unit 3.

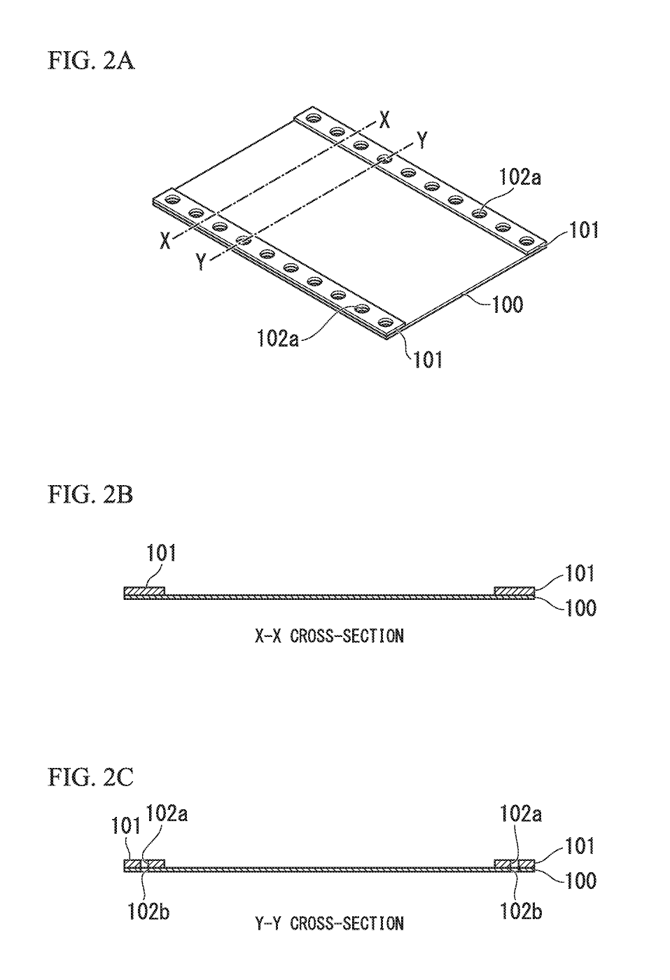

The constitution of the transfer film 100 will now be described, making reference to FIG. 2A to FIG. 2C. FIG. 2 is an oblique view of the constitution of the transfer film 100. FIG. 2B is a cross-sectional view of along the line segment X-X shown in FIG. 2A. FIG. 2C is a cross-sectional view along the line segment Y-Y shown in FIG. 2A.

The transfer film 100, as shown in FIG. 2A to FIG. 2C, is provided with a pair of guide members 101 that are guided and supported along the transporting direction (longitudinal direction). The pair of guide members 101 are disposed along the edge parts on both side of, and in a direction that is parallel to the transporting direction of the transfer film 100.

The pair of guide members 101 are provided with a plurality of holes 102a that are arranged with a prescribed spacing. In correspondence thereto, through holes 102b having the same size as the holes 102a are provided at positions in the transfer film 100 that overlap with the holes 102a.

Polyvinylidene fluoride (PVDF), nitrocellulose or the like can be used as the transfer film 100. General-purpose plastics such as polypropylene (PP), polyvinyl chloride (PVC), polyethylene (PE), polystyrene (PS), acrylonitrile butadiene styrene

(ABS, acrylonitrile styrene (AS), or polymethyl methacrylate (PMMA) can be used as the guide members 101. It is preferable that the width of the guide members 101 be approximately 1 mm to 5 mm and that the thickness thereof be approximately 0.2 mm to 1 mm. In the present embodiment, ployvinylidene fluoride (PVDF) is used for as the transfer film 100, and polypropylene (PP) is used as the guide members 101.

The transporting unit 8, as shown in FIG. 1, has a plurality of guide rollers 11a to 11e between the transfer film supply unit 2, the electrophoresis transfer unit 3, and the sample making unit 4. A plurality of guide pins (not shown) are provided with a prescribed spacing in the circumferential direction on the plurality of guide rollers 11a to 11e. In the transporting unit 8, with the holes 102a of the guide members 101 and the through holes 102b of the transfer film 100 engaged with the guide pins, the plurality of guide rollers 11a to 11e are rotated in the transporting direction, so as to transport the transfer film 100 between these plurality of guide rollers 11a to 11e.

The electrophoresis transfer unit 3 generally has a hydrophilizing spray 12 that hydrophilizes the transfer film 100, a gel filling tank 15 that is filled will a gel 14 for electrophoresis between a pair of top and bottom substrates 13a and 13b, a cathode buffer tank 17 that is provided with a cathode 16, an anode buffer tank 19 that is provided with an anode 18, a sampler 20 that supplies a sample (not shown), and a solvent chip 21 that guides the sample supplied from the sampler 20 to the gel filling tank 15.

The cathode buffer tank 17 and the anode buffer tank 19 have a reservoir of buffer solution L. One end side of the gel filling tank 15 is disposed so as to be immersed into the buffer solution L in the cathode buffer tank 17. The one end side of the gel filling tank 15 is provided with an aperture 15a into which the sample is introduced. The other end side of the gel filling tank 15 is disposed so as to be immersed in the buffer solution L in the anode buffer tank 19. This other end side of the gel filling tank 15 is provided with a slit 15b through which the transfer film 100 passes.

In the electrophoresis transfer unit 3, the hydrophilizing spray 12 hydrophilizes the transfer film 100 by coating the transfer film 100 transported by the transporting unit 8 with a treatment solution H. Methanol or ethanol can be used, for example, as the treatment solution H.

Having been subjected to hydrophilizing, the transfer film 100 passes through the slit 15b of the gel filling tank 15 as it is guided by the guide rollers 11a to 11d. The sample supplied by the sampler 20 is guided to the aperture 15a of the gel filling tank layer 15, via the solution chip 21.

By applying a direct current voltage between the cathode 16 and the anode 18, the sample moves from one end side to the other end side of the gel 14. When this occurs, the sample is separated by electrophoresis in accordance with the difference in the molecular weight of the proteins. Having been separated by electrophoresis, the sample is transferred to the transfer film 100 that passes through the slit 15b.

The transfer film 100 onto which the sample has been transferred is transported by the transporting unit 8 from the electrophoresis transfer unit 3 to the sample making unit 4. The sample making unit 4 has a carrier mounter 22 that mounts the carrier 103 to the transfer film 100 onto which the sample has been transferred, and a package housing unit 23 that houses the transfer film 100 onto which the carrier 103 has been mounted into a package 104.

The carrier mounter 22 has, between the guide roller 11d and the guide roller 11e, a pressure roller 24, a hot press 25, and a cutter 26. The pressure roller 24 presses the long ribbon-shaped carrier 103 fed out from the carrier roll (not shown,) onto which the long ribbon-shaped carrier 103 is wound, against the transfer film 100. The hot press 25 hot presses the carrier 103 onto the transfer film 100. The cutter 26 cuts the carrier 103, leaving the part that is hot-pressed to the carrier 103.

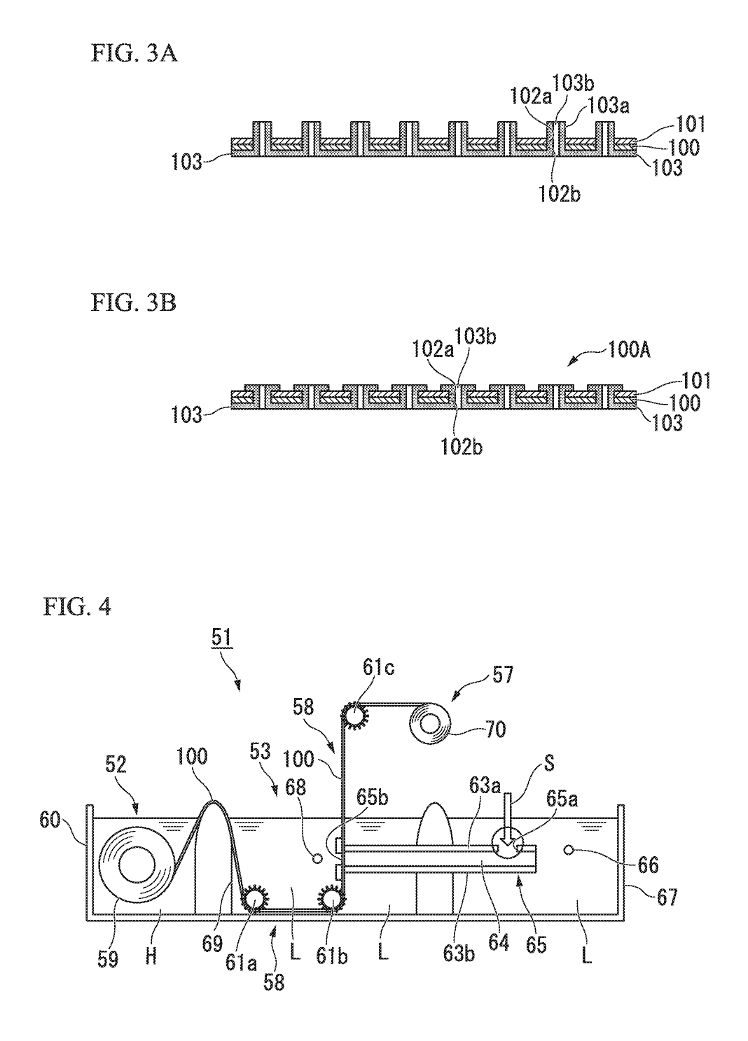

In this case, the condition before the carrier 103 is hot-pressed onto the transfer film 100 is shown in FIG. 3A, and the condition after the carrier 103 is hot-pressed onto the transfer film 100 is shown in FIG. 3B.

As shown in FIG. 3A, the carrier 103 has protrusions 103a that engage with the holes 102a of the guide members 101 and the through holes 102b of the transfer film 100. Through holes 103b are formed in the protrusions 103a. As shown in FIG. 3B, the protrusions 103a are pressed flat by the hot press 25 and are integrated with the transfer film 100. The result is that the transfer film 100 is fixed and supported and improved in rigidness by the carrier 103.

The transfer film 100 that is integrated with the carrier 103, as shown in FIG. 1, is transported to the package housing unit 23 by the rotation of the guide roller 11e in the transporting direction, with the guide pins engaged with the through holes 103b of the carrier 103. At the package housing unit 23, the transfer film 100 that is integrated with the carrier 103 is housed into a package 104, thereby making a sample cell 100A. The thus-made sample cell 100A is transported by the transporting unit 8 to the post-processing unit 5.

A material having a rigidity higher than that of the transfer film 100, such as polytetrafluoroethylene (PTFE), polymethyl methacrylate (PMMA), polyethylene terephthalate (PET), or polypropylene (PP) can be used as the carrier 103. As the package 104, for example, polymethyl methacrylate (PMMA), polyethylene terephthalate (PET), or polyethylene (PE) can be used. In the present embodiment, polytetrafluoroethylene (PTFE), which has high resistance to chemicals and heat and has small coefficient of friction, is used for the carrier 103, and polymethyl methacrylate (PMMA), which has high transparency, is used as the package 104.

The post-processing unit 5 performs processing of the transfer film 100 in the package 104, to which the sample has been transferred, to obtain a transfer image of the sample, by, for example, blocking, dying, color removal, washing, drying, and incubation.

In the post-processing unit 5, an operation that agitates the sample cell 100A can be done during processing. The processed sample cell 100A is transported by the transporting unit 8 to the measurement unit 6.

The measurement unit 6 has an illuminator 27 that shines a measurement light B onto the sample cell 100A and an imaging unit 28 that captures a transfer image of the sample. An excited light source such as a laser diode (LD) may be used as the illuminator 27. An imaging element such as a charge-coupled device (CCD) may be used as the imaging unit 28. In the measurement unit 6, measurement is performed while scanning the illuminator 27 and the imaging unit 28.

In the automatic electrophoresis apparatus 1, by measuring the obtained transfer image of the sample, it is possible to test for the presence of antibodies in the sample. After testing, the sample cell 100A is transported by the transporting unit 8 to the sample storage unit 7.

The sample storage unit 7 has a storage container 29 that stores a plurality of sample cells 100A. A plurality of sample cells 100A are stored in a row in the storage container 29.

In the automatic electrophoresis apparatus 1 of the present embodiment, by providing guide members 101 on the transfer film 100, at the time of transporting, the transfer film 100 makes contact with the guide rollers 11a to 11e and the like of the transporting unit 8, via the intervening guide members 101. For this reason, the transfer film 100 does not come into direct contact with the guide rollers 11a to 11e and the like. This enables prevention of contamination between samples transferred to the transfer film 100 (cross-contamination).

Also, the rigidity of the edge parts on both side of the transfer film 100, at which the pair of guide members 101 are provided, can be improved. This enables avoidance of mechanical problems such as the transfer film 100 breaking when it is transported in the automatic electrophoresis apparatus 1.

In the automatic electrophoresis apparatus 1 of the present embodiment, transporting is done in the condition in which the guide pins of the guide rollers 11a to 11e are engaged in the plurality of holes 102a and through holes 102b provided in the pair of guide members 101 and the transfer film 100. This enables improvement of the accuracy of transporting the transfer film 100 and an improvement in the reliability.

Additionally, in the automatic electrophoresis apparatus 1 of the present embodiment, by mounting the carrier 103 to the transfer film 100 to which the sample has been transferred, not only is the rigidity of the transfer film 100 improved, but also movement of the transfer film 100 housed in the package 104 is prevented. In this case, because the transfer film 100 does not come into contact with the package 104, it is possible to prevent sample contamination (cross-contamination).

Although FIG. 1 shows a constitution of the automatic electrophoresis apparatus 1 in which the measurement unit 6 is provided, the measurement unit 6 may be omitted. For example, rather than making an optical measurement using the above-noted measurement unit 6, the sample can be measured using another measurement apparatus such as a mass analyzer that is separate from the automatic electrophoresis apparatus 1.

### Second Embodiment

Next, an automatic electrophoresis apparatus 51 shown in FIG. 4 will be described as the second embodiment.

FIG. 4 is a schematic representation of the general constitution of the automatic electrophoresis apparatus 51.

In the description to follow, parts equivalent to those in the above-noted automatic electrophoresis apparatus 1 are assigned the same reference symbols, and the descriptions thereof will be omitted.

As shown in FIG. 4, the automatic electrophoresis apparatus 51 generally has a transfer film supply unit 52, an electrophoresis transfer unit 53, a sample storage unit 57, and a transporting unit 58.

The transfer film supply unit 52 has a transfer film roll 59 onto which a long ribbon-shaped transfer film 100 is wound and a hydrophilizing tank 60 that hydrophilizes the transfer film 100. The transfer film roll 59 is disposed so that it is immersed in the processing solution H within the hydrophilizing tank 60. The transfer film 100 is transported by the transporting unit 58 from the transfer film supply unit 52 to the electrophoresis transfer unit 53.

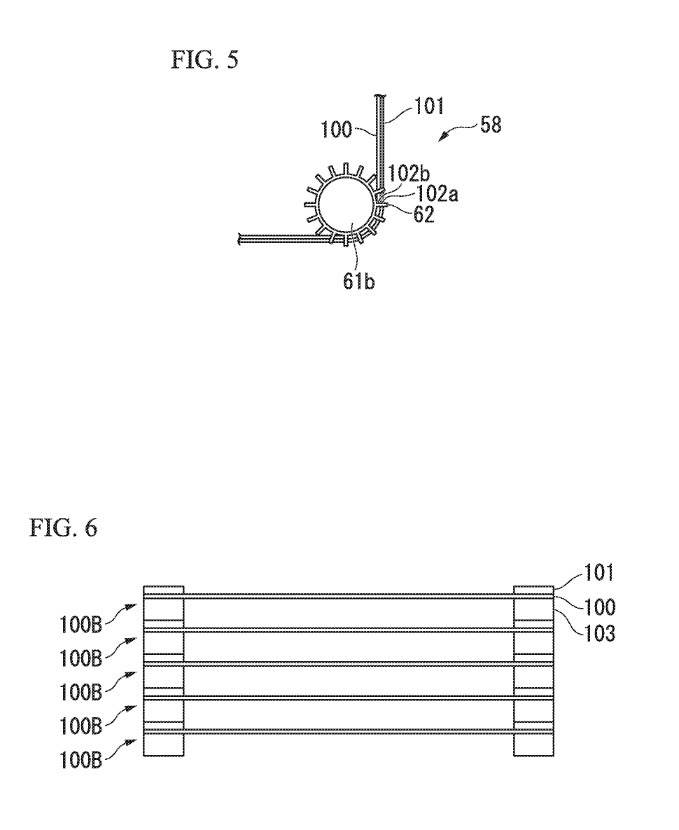

The transporting unit 58 has a plurality of guide rollers 61a to 61c between the transfer film supply unit 52, the electrophoresis transfer unit 53, and the sample storage unit 57. A plurality of guide pins 62, as shown in FIG. 5, are provided with a prescribed spacing in the circumferential direction of the plurality of guide rollers 61a to 61c. Of the plurality of guide rollers 61a to 61c shown in FIG. 4, FIG. 5 shows, in enlarged schematic form, the guide roller 61b.

In the transporting unit 58, with the holes 102a of the guide members 101 and the through holes 102b of the transfer film 100 engaged with the guide pins 62, the plurality of guide rollers 11a to 11e are rotated in the transporting direction, so as to transport the transfer film 100 between the plurality of guide rollers 61a to 61c.

The electrophoresis transfer unit 53 generally has, as shown in FIG. 4, a gel filling tank 65 that is filled with a gel 64 for electrophoresis between a pair of top and bottom substrates 63a and 63b, a cathode buffer tank 67 that is provided with a cathode 66, an anode buffer tank 69 that is provided with an anode 68.

The cathode buffer tank 67 and the anode buffer tank 69 has a reservoir of buffer solution L. One side end side of the gel filling tank 65 is disposed so as to be immersed in the buffer solution L in the cathode buffer tank 67. The one end side of the gel filling tank 65 is provided with an aperture 65a into which the sample S is introduced. The other end side of the gel filling tank 65 is disposed so as to be immersed in the buffer solution L in the anode buffer tank 69. This other end side of the gel filling tank 65 is provided with a slide 65b through which the transfer film 100 passes.

In the electrophoresis transfer unit 53, the transfer film 100 passes through the slit 65b of the gel filling tank 65 as it is guided by the guide rollers 61a to 61b. The sample S is introduced to the aperture 65a of the gel filling tank layer 65.

By applying a direct current voltage between the cathode 66 and the anode 68, the sample S moves from one end side to the other end side of the gel 54. When this occurs, the sample S is separated by electrophoresis, in accordance with the difference in the molecular weight of the proteins. Having been separated by electrophoresis, the sample S is transferred to the transfer film 100 that passes through the slit 65b.

The transfer film 100 onto which the sample S has been transferred is transported by the transporting unit 58 from the electrophoresis transfer unit 53 to the sample storage unit 57. The sample storage unit 57 has a sample roll 70 onto which the transfer film 100 onto which the sample S has been transferred is taken up. The sample roll 70 is controlled independently from the transfer film roll 59. The transfer film 100 that has been taken up by the sample roll 70 is fed to a post-processing unit (not shown) and, after processing to obtain a transfer image of the sample S, is fed to the measurement unit, at which it is subjected to tests for the presence of antibodies in the sample S.

The automatic electrophoresis apparatus 51 of the present embodiment can achieve the same effect as that of the above-noted automatic electrophoresis apparatus 1. That is, by providing the guide members 101 on the transfer film 100, at the time of transporting, the transfer film 100 makes contact with the guide rollers 61a to 61c and the like of the transporting unit 58, via the intervening guide members 101. For this reason, the transfer film 100 does not come into direct contact with the guide rollers 61a to 61c and the like. This enables prevention of contamination between samples transferred to the transfer film 100 (cross contamination).

Also, the rigidity of the edge parts on both side of the transfer film 100, at which the pair of guide members 101 are provided, can be improved. This enables avoidance of mechanical problems such as the transfer film 100 breaking when it is transported in the automatic electrophoresis apparatus 51.

In the automatic electrophoresis apparatus 51 of the present embodiment, transport is done in the condition in which the guide pins 62 of the guide rollers 61a to 61c are engaged in the plurality of holes 102a and through holes 102b provided in the pair of guide members 101 and the transfer film 100. This enables improvement of the accuracy of transporting the transfer film 100 and an improvement in the reliability.

The present invention is not restricted to the above-noted embodiments and can be subjected to various changes, within the scope of the spirit of the present invention.

For example, in the automatic electrophoresis apparatus 1 shown in FIG. 1, although the description has been of when a sample cell 100A, in which the transfer film 100 onto which the carrier 103 has been mounted is housed in a package 104 and is stored by the storage container 29 of the sample storage unit 7, the transfer film 100 onto which the carrier 103 has been mounted (sample cells 100B) can be, for example, stored in a stacked condition, as shown in FIG. 6.

In this case, a plurality of stacked transfer films 100 make contact via the intervening guide members 101 and carriers 103. For this reason, the plurality of stacked transfer films 100 do not contact each other directly. This can prevent contamination between samples transferred to the transfer film 100 (cross-contamination).

In the automatic electrophoresis apparatuses according to embodiments of the present invention, the constitution is not restricted to above-described one in which the sample cell making unit is disposed between the electrophoresis transfer unit and the post-processing unit, and a constitution may be adopted in which it is disposed between the transfer film supply unit and the electrophoresis transfer unit. The sample storage unit may be disposed after the measurement unit, as noted above, or may be disposed after the electrophoresis transfer unit.

An automatic electrophoresis apparatus according to the embodiments of the present invention is not restricted to application to testing for serum proteins as noted above, and can be applied to, for example, testing for disease-related markers (for example, cancer markers).

### INDUSTRIAL APPLICABILITY

An embodiment of the present invention can be applied to an automatic electrophoresis apparatus that requires improved transfer film transporting accuracy, while preventing cross-contamination of the transfer film.

### DESCRIPTION OF THE REFERENCE SYMBOLS

1 Automatic electrophoresis apparatus (first embodiment)
2 Transfer film supply unit
3 Electrophoresis transfer unit
4 Sample making unit
5 Post-processing unit
6 Measurement unit
7 Sample storage unit
8 Transporting unit
9 Transfer film roll
10 Cutter
11a to 11e Guide rollers
12 Hydrophilizing spray
13a, 13b Substrate
14 Gel
15 Gel filling tank
15a Aperture
15b Slit
16 Cathode
17 Cathode buffer tank
18 Anode
19 Anode buffer tank
20 Sampler
21 Solution chip
22 Carrier mounting unit
23 Package storage unit
24 Pressure roll
25 Hot press
26 Cutter
27 Illuminator
28 Imaging unit
29 Storage container
51 Automatic electrophoresis apparatus (second embodiment)
52 Transfer film supply unit
53 Electrophoresis transfer unit
57 Sample storage unit
58 Transporting unit
59 Transfer film roll
60 Hydrophilizing tank
61a to 61c Guide roller
62 Guide pin
63a, 63b Substrate
64 Gel
65 Gel filling tank
65a Aperture
65b Slit
66 Cathode
67 Cathode buffer tank
68 Anode
69 Anode buffer tank
70 Sample roll
100 Transfer film
100A, 100B Sample cell
101 Guide member
102a Hole
102b Through hole
103 Carrier
103a Protrusion
104 Package
L Buffer solution
H Processing solution
B Measurement light
S Sample

1. An automatic electrophoresis apparatus comprising:
a transfer film supply unit configured to supply a transfer film;
a sample transfer unit configured to transfer a sample separated by electrophoresis to the transfer film;
a post-processing unit configured to perform processing of the transfer film, to which the sample has been transferred, to obtain a transfer image thereof; and
a transporting unit configured to transfer the transfer film along a transporting direction between each of units,
wherein the transfer film is provided with guide members that are configured to guide and support along the transporting direction.

2. The automatic electrophoresis apparatus according to claim 1,
wherein the guide members are configured to be disposed along edge parts on both side of the transfer film, and disposed in a direction that is parallel to the transporting direction of the transfer film.

3. The automatic electrophoresis apparatus according to claim 1,
wherein the guide members are configured to be provided with a plurality of holes that are arranged with a prescribed spacing.

4. The automatic electrophoresis apparatus according to claim 1, the automatic electrophoresis apparatus further comprising a sample making unit configured to oppose the guide members of the transfer film and make a sample cell onto which a carrier is mounted.

5. The automatic electrophoresis apparatus according to claim 4, the automatic electrophoresis apparatus further comprising a sample storage unit configured to store the sample cell.

6. The automatic electrophoresis apparatus according to claim 1, the automatic electrophoresis apparatus further comprising a measurement unit configured to measure a transfer image of the sample.
